(19) United States
(12) Patent Application Publication
(10) Pub. No.: US 2026/0021567 A1
(43) Pub. Date: Jan. 22, 2026

(54) ELECTRIC TOOL AND METHOD FOR OPERATING AN ELECTRIC TOOL

(71) Applicant: ANDREAS STIHL AG & Co. KG, Waiblingen (DE)

(72) Inventors: Alexander SCHEEL, Schwäbisch Gmünd (DE); Oliver SCHMIDT, Waiblingen (DE); Marcel WITT, Alfdorf (DE)

(73) Assignee: ANDREAS STIHL AG & Co. KG, Waiblingen (DE)

(21) Appl. No.: 19/274,025

(22) Filed: Jul. 18, 2025

(30) Foreign Application Priority Data
Jul. 18, 2024 (DE) 10 2024 120 294.7

(51) Int. Cl. B25F 5/00; B25F 5/02; H02K 9/04

(52) U.S. Cl. CPC B25F 5/008; B25F 5/02; H02K 9/04

(57) ABSTRACT

An electric tool includes a drive unit for driving a tool unit in an operating state. A connection unit with at least one connection contact element transmits electrical energy from an energy supply device of the electric tool to the drive unit. A fan unit generates an air flow. A housing accommodates the drive unit, the connection unit, and the fan unit. A first air passage opening and a second air passage opening are formed on the housing. The first and second air passage openings are connected to one another with the fan unit via a duct for guiding the air flow along a flow direction. The duct is defined in sections by the connection unit and guides the air flow to dissipate heat generated at the connection unit from the housing while in the operating state. The electric tool is operable by a method.

### CROSS-REFERENCE TO RELATED APPLICATIONS

This application claims priority under 35 U.S.C. § 119 to German patent application DE 10 2024 120 294.7, filed Jul. 18, 2024, the entire disclosure of which is incorporated herein by reference.

### BACKGROUND OF THE DISCLOSURE

### 1. Field of the Disclosure

The present disclosure is in the field of cooling technology for electric tools and relates to an electric tool and a method for operating, in particular for cooling, an electric tool.

### 2. Description of Related Art

Electric tools with electric drive units are used in different areas and for different purposes. In battery-operated portable electric tools, such as electric chain saws, cut-off grinders, blowers, suction devices, etc., relatively powerful drive units in the form of electric motors and associated energy supply devices in the form of manually replaceable batteries are used. The drive units in turn drive the respective tool units of the electric tools. Electrical energy is usually transmitted from the energy supply device to the drive unit by means of insulated electrical conductors and so-called power electronics of a control unit to a connection unit of the drive unit.

In an operating state of the electric tool, heat is generated due to various factors or causes in the units and elements involved in the transmission and/or conversion of electrical energy. The generation of heat depends, for example, on a contact resistance between the respective contact elements, a current intensity of the operating current and/or wear of the respective contact elements and other electrical connection components.

To ensure the intended function of an electric tool in view of heat generation in an operating state, a cooling concept for respective components, i.e. units and elements of the electric tool, is desirable.

### SUMMARY OF THE DISCLOSURE

It is an object of the present disclosure to provide an electric tool that is characterized by an improved cooling concept in an operating state. Furthermore, it is an object of the present disclosure to provide a method for operating an electric tool, in particular a method for cooling the electric tool, which is improved above all in terms of effect and efficiency.

The object is solved by the features of the independent claims. Further embodiments and applications of the present disclosure result from the dependent claims and are explained in more detail in the following description with partial reference to the figures.

According to a first general aspect, the present disclosure relates to an electric tool, in particular a portable electric tool, comprising: a drive unit for driving a tool unit of the electric tool in an operating state; a connection unit with at least one connection contact element for transmitting electrical energy of an energy supply device of the electric tool to the drive unit; a fan unit for generating an air flow; a housing for accommodating the drive unit, the connection unit for the drive unit and the fan unit, a first air passage opening and a second air passage opening being formed on the housing, which are connected to one another with the fan unit via a duct for guiding the air flow along a flow direction, the duct being defined in sections by the connection unit for the drive unit in order to substantially dissipate heat generated in the operating state at the connection unit for the drive unit from the housing by means of the air flow, in particular to dissipate it from the housing in an at least partially defined manner.

The present disclosure provides an electric tool in which, among other things, a targeted cooling of the connection unit for the drive unit can be realized in an operating state of the electric tool. The cooling is essentially achieved by means of the air flow in the duct, which is directly defined in sections by the drive unit. By forming the duct in sections through the connection unit itself, heat generated at the connection unit can be directly absorbed and dissipated by the air flow, which contributes to further improved cooling of the electric tool in an operating state.

The drive unit can be a rotary field machine in the form of a brushless three-phase motor, which is characterized, for example, by a comparatively high power density, efficiency, and durability. The three-phase motor can comprise a stator as the stationary part and a rotor as the rotating part.

In particular, the connection unit is spatially arranged and/or formed directly on the drive unit. In other words, the connection unit is spatially coupled directly to the drive unit. It is possible that the connection unit is a component of the drive unit and/or forms a section of the drive unit. In other words, the connection unit is in particular a drive connection unit.

The heat generated can be dissipated from the housing in an at least partially defined manner by means of the air flow. The at least partially defined dissipation of the heat can be characterized by at least one of the following and/or be dependent on at least one of the following: a certain resulting flow velocity of the air flow, a certain medium or resulting pressure of the air flow, a certain resulting volume flow and/or a certain resulting minimum convection surface of the drive unit defining the duct in sections. The fan unit can be directly coupled to the drive unit and configured to be driven by the drive unit.

With the present disclosure, it is possible, for example, not only to cool the drive unit in an operating state of the electric motor, but in particular also to specifically cool the connection unit, which is immediately (directly) associated with the drive unit.

According to a further aspect of the present disclosure, it can be provided that the duct extends substantially in a circumferential direction of the drive unit in sections between the drive unit and the connection unit in order to substantially dissipate, in particular at least partially dissipate in a defined manner, heat generated in the operating state at the drive unit by means of the air flow.

This allows, for example, a compact design of the electric tool to be realized, while also ensuring effective cooling of the drive unit and, in particular, the connection unit.

The connection unit can, in particular, comprise a connection block for supporting the at least one connection contact element, wherein the connection block forms a duct wall section of the duct for guiding the air flow and/or divides a duct cross-section of the duct in sections essentially along the flow direction.

This can further improve the dissipation of heat generated at the connection unit and in particular at the connection block and further optimize the cooling of the electric tool. In particular, the connection block can be formed as a central mounting block for the mechanical and electrical connection of electrical conductors to the at least one connection contact element. The mechanical and electrical connection of at least one electrical conductor to the at least one connection contact element can be realized, for example, by means of a plug connection, a screw connection, a clamp connection and/or a combination thereof.

It is possible that the connection unit, in particular a connection block of the connection unit for supporting the at least one connection contact element, is formed plate-shaped and/or ribbed at least within the duct.

As a result, for example, the cooling efficiency can be further increased due to increased cooling surfaces and cooling elements, while the mechanical stability of the connection unit is essentially maintained. It is possible that, in addition to or as an alternative to at least one rib, the connection block comprises further or other cooling elements, for example in the form of at least one fin.

Additionally or alternatively, the connection unit, in particular a connection block of the connection unit for supporting the at least one connection contact element, can extend at least within the duct substantially along the flow direction and/or substantially parallel to at least one duct wall section of the duct.

The connection unit and, in particular, a connection block of the connection unit can be formed as a so-called terminal board or comprise such a board. By extending the connection unit, in particular the connection block, essentially along the flow direction and/or essentially parallel to at least one duct wall section of the duct, improved flow conditions for the air flow can be provided, for example, which in turn leads to improved dissipation of generated heat. The at least one duct wall section can, for example, be formed by the housing or be a component of the housing.

According to a further aspect of the present disclosure, it can be provided that the connection unit comprises at least three connection contact elements which are arranged within the duct substantially in a longitudinal direction substantially transverse to the flow direction or which are arranged one behind the other along the flow direction.

The at least three connection contact elements can be part of the connection block and/or arranged and/or supported on the connection block.

It is possible that the duct is formed by a first duct wall section and by a second duct wall section, wherein the first duct wall section encases the drive unit in sections in a circumferential direction and the second duct wall section is arranged at a distance from the first duct wall section, and wherein a recess is formed in the first duct wall section and in the second duct wall section in each case, which recess extends in sections substantially along the flow direction and through which the connection unit, in particular a connection block of the connection unit, protrudes in order to connect the connection unit to the drive unit electrically and/or mechanically.

The respective recess can, for example, be formed as an elongated hole or a slot. The connection unit, in particular the connection block, can be formed angled, with one leg section protruding through the first and/or through the second duct wall section and with a second leg section defining the duct in sections and/or supporting the at least one connection contact element.

By penetrating the connection unit, in particular the connection block, through the respective recess, further improved cooling can be realized on the one hand while at the same time maintaining a compact design of the electric tool.

It is possible that at least one gap is formed between the connection unit and the recess of the first duct wall section, and/or between the connection unit and the recess of the second duct wall section, in each case essentially along the flow direction and/or essentially transversely to the flow direction, wherein the at least one gap comprises a width in a range from approximately 0.5 mm to approximately 5.0 mm, in particular from approximately 0.5 mm to approximately 3.0 mm. The gap can also comprise a width in a range of more than 0.0 mm to at least approximately 5.0 mm. In particular, the gap can comprise a width in a range from approximately 0.5 mm to approximately 2.0 mm. A width of the at least one gap can be smaller substantially along the flow direction (along the duct) than a width of the at least one gap substantially transverse to the flow direction (transverse to the duct). The at least one gap can comprise a width of approximately 1.2 mm essentially along the flow direction and/or the at least one gap can comprise a width of approximately 3.3 mm essentially transverse to the flow direction.

The gap, for example, does not significantly influence the air flow in the duct with regard to the dissipation of generated heat. However, air can be drawn into the duct via the at least one gap by a negative pressure generated by the air flow, which in turn realizes a dissipation of generated heat at further points, units and/or elements.

According to a further aspect of the present disclosure, it can be provided that a power control unit for adjusting, in particular for controlling and/or regulating, the drive unit and/or the fan unit is accommodated in the housing, and that the duct is defined in sections by the power control unit in order to substantially dissipate, at least partially in a defined manner, heat generated in the operating state at the power control unit by means of the air flow.

As a result, the power control unit can be cooled even more effectively in an operating state of the electric tool and already with the available air flow by dissipating generated heat.

In particular, the power control unit can be arranged essentially downstream of the connection unit in the flow direction and/or comprise at least one cooling element for transferring the generated heat, which cooling element extends in sections essentially along the flow direction. The at least one cooling element can be formed as a rib or a fin, which increases the resulting cooling surface of the power control unit.

It is possible that the duct within the housing extends in a transverse direction perpendicular to a circumferential direction of the drive unit in a spiral shape in sections and/or in a straight line in sections.

As a result, for example, further units and/or elements of the electric tool can be caught for cooling by means of the air flow, for example bearing elements of the drive unit and/or tool elements of a tool unit of the electric tool to be driven by the drive unit.

According to a further aspect of the present disclosure, it can be provided that the first air passage opening for introducing the air flow into the housing is arranged and/or formed as an air inlet opening on a first housing side, and that the second air passage opening for discharging the air flow from the housing is arranged as an air outlet opening on a second housing side, the first housing side and the second housing side are aligned and/or arranged differently with respect to one another in order to prevent the introduction of discharged air flow into the first air passage opening.

The at least one connection contact element can extend at least in sections into the duct within a duct segment of the duct. The connection unit can be arranged and configured to contact at least one electrical conductor, which is assigned to the at least one connection contact element, within a housing segment, wherein the duct segment is arranged between the first passage opening and the fan unit.

According to a further aspect of the present disclosure, it can be provided that a duct cross-section of the duct, in particular as the resulting flow cross-section of the duct, tapers to a minimum at at least one point along the flow direction downstream of the first air passage opening and upstream of the connection unit or at least upstream of the power control unit, in order to increase an average or resulting flow velocity of the air flow upstream of the connection unit or at least upstream of the power control unit in the operating state.

This allows, for example, an improved cooling function to be realized in a comparatively simple manner at defined points or in defined areas of the duct. In other words, the duct can be formed in sections as a so-called convergent cooling duct, in which the average or resulting flow velocity of the air flow is increased.

It is possible that the first air passage opening is arranged on an outer wall of the housing and the duct is arranged inside the housing and both being configured with respect to each other to deflect the air flow at least once in the flow direction immediately after passing through the first air passage opening in the operating state, in particular to deflect it in an angular range between 0° and 120°.

It is possible that the fan unit is arranged downstream in the flow direction and is configured to generate a negative pressure in the air flow in the duct at least between the first passage opening and the drive unit in the operating state and/or to generate an overpressure in the air flow in the duct at least between the drive unit and the second air passage opening.

This makes it possible, for example, for air for cooling (cooling air) to be drawn into the duct from an environment of the electric tool by means of the negative pressure via the first air passage opening and, after heat has been absorbed, to be blown out of the duct via the second air passage opening by means of the overpressure.

According to a second general aspect, the present disclosure relates to a method for operating an electric tool, in particular as disclosed herein, with a housing in which a drive unit for driving a tool unit of the electric tool in an operating state, a connection unit with at least one connection contact element for transmitting electrical energy from an energy supply device of the electric tool to the drive unit, and a fan unit for generating an air flow are accommodated, a first air passage opening and a second air passage opening being formed on the housing, which are connected to one another with the fan unit via a duct for guiding the air flow along a flow direction, and the duct being defined in sections by the connection unit for the drive unit, wherein in the operating state the fan unit generates the air flow in the duct and substantially dissipates a generated heat at the connection unit from the housing by means of the air flow, in particular dissipates it at least partially in a defined manner from the housing.

In order to avoid repetition, features directed purely to the apparatus of the electric tool according to the disclosure and/or disclosed in connection therewith should also be regarded as disclosed according to the method and be claimable, and vice versa.

### BRIEF DESCRIPTION OF THE DRAWINGS

The previously described embodiments and features of the present disclosure can be combined with each other as desired or appropriate. Further or other details and advantageous effects of the present disclosure will be explained in more detail below with reference to the accompanying figures.

FIG. 1 shows a first embodiment of the electric tool according to the present disclosure with an electric supply device in a perspective view, wherein a tool unit of the electric tool is hidden and/or not visible.

FIG. 2 shows the electric tool from FIG. 1 in a front view (main view), wherein a separate protective element is mounted on the electric tool.

FIG. 3 shows a first section of the electric tool from FIG. 1 in a perspective view.

FIG. 4 shows a second section of the electric tool from FIG. 1 in a perspective view.

FIG. 5 shows a first sectional view (front view) of the electric tool from FIG. 1, with units and elements being hidden.

FIG. 6 shows the electric tool from FIG. 1 in a second sectional view (front view).

Identical or functionally equivalent devices, units or elements are marked with the same reference signs in the figures. For their explanation, reference is also made in part to the description of other embodiments and/or figures in order to avoid repetition.

### DETAILED DESCRIPTION OF THE DISCLOSURE

The following detailed description of the embodiments shown in the figures serves to illustrate or clarify in more detail and is in no way intended to limit the scope of the present disclosure.

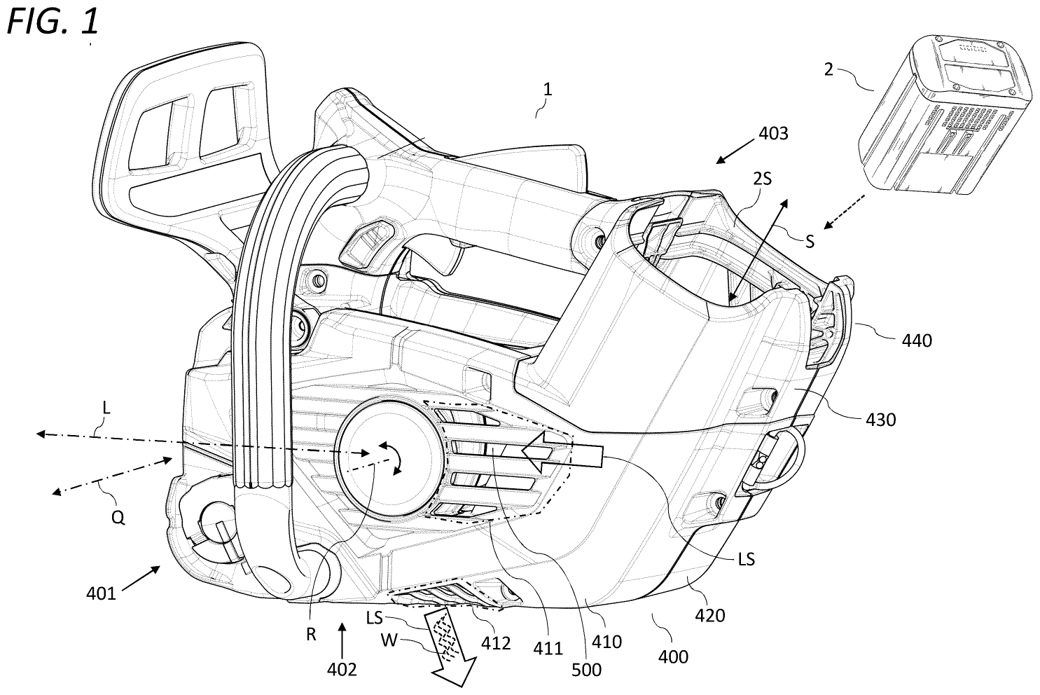

FIG. 1 shows a perspective view of a first embodiment of the electric tool 1 according to the present disclosure with an energy supply device 2.

The electric tool 1 can be a mobile, a portable, a manually actuable, a self-sufficient (mains-independent) operable and/or a motor-driven electric tool. The electric tool 1 can, for example, be formed as one of the following: a garden tool, for example in the form of a trimmer, shears, a scythe, a brush cutter, a leaf blower, a leaf vacuum; a forestry tool, for example in the form of a chainsaw; a cleaning tool, for example in the form of a high-pressure cleaner; another electric tool, for example in the form of a drill, a cut-off grinder, a saw, a vacuum cleaner, a compressor. Further forms and configurations of the electric tool 1 are possible.

In the embodiment shown, the electric tool 1 is a portable motor-driven electric tool 1 in the form of a chainsaw operated by an electric motor, although the tool unit of the electric tool 1 is hidden and/or not visible for reasons of clarity. The chainsaw 1 is a so-called pruning saw. The hidden and/or invisible tool unit comprises a drive sprocket for a saw chain, a saw chain and an associated guide bar for the saw chain.

The energy supply device 2 is formed as a separate device and is configured to supply electrical energy to the electric tool 1. The energy supply device 2 can be formed as a portable accumulator that can be manually assembled/disassembled and/or replaced without tools and can, for example, comprise a plurality of lithium-ion cell units.

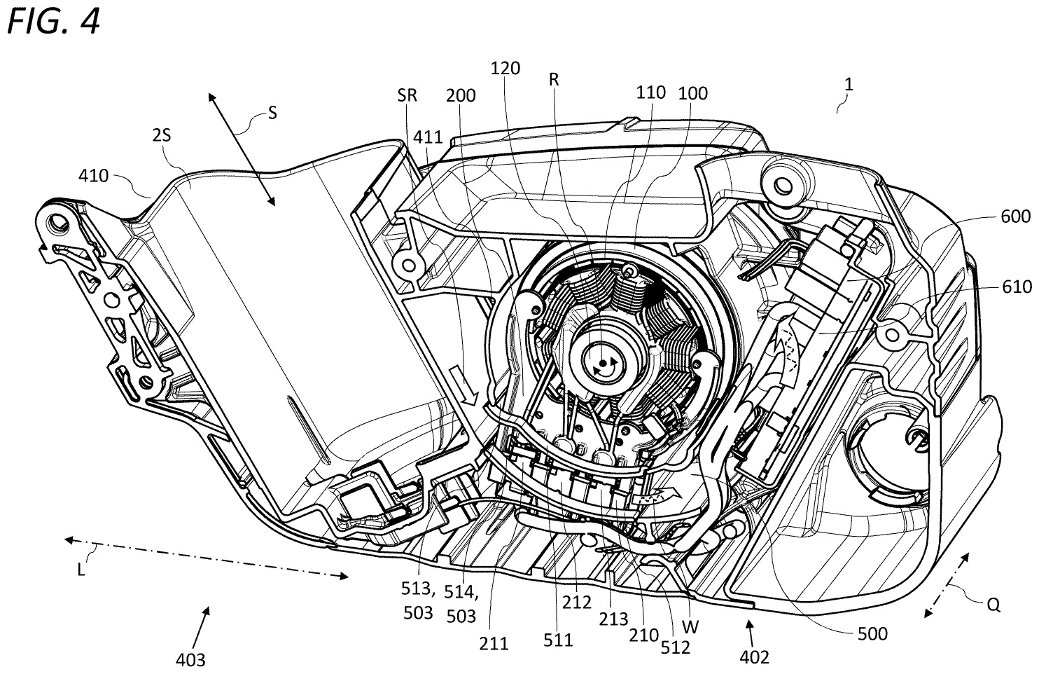

The electric tool 1 comprises several housing parts for forming a housing 400, of which the housing parts 410, 420, 430 and 440 are marked in the figures for reasons of clarity. The housing 400 is thus made up of several parts. The housing parts 410, 420, 430, 440 define the housing 400 on respective housing sides, of which the housing sides 401, 402 and 403 are marked in FIG. 1. The housing side 401 represents a front side 401 of the electric tool 1, the housing side 402 represents a bottom side 402 of the electric tool 1, and the housing side 403 represents a rear side of the electric tool 1 (see also FIG. 4). The front side 401 and the bottom side 402 are defined, inter alia, by the housing part 410. The front side 401 and the underside 402 are aligned differently to one another.

The housing 400 is formed, for example, from a material based on a substantially dimensionally stable plastic, for example by at least one casting process and/or by at least injection process. It is understood that walls and/or wall sections are formed within the housing 400 by the respective housing parts 410, 420, 430, 440, wherein the walls and/or wall sections serve, inter alia, to accommodate and/or fasten units and/or elements of the electric tool 1.

The housing parts 430 and 440 together form a partial section of a slot 2S for receiving the energy supply device 2 in an assembly direction S and for supporting the energy supply device 2 in an assembly state. The assembly direction S represents a plug-in direction for manual tool-free assembly and disassembly of the energy supply device 2.

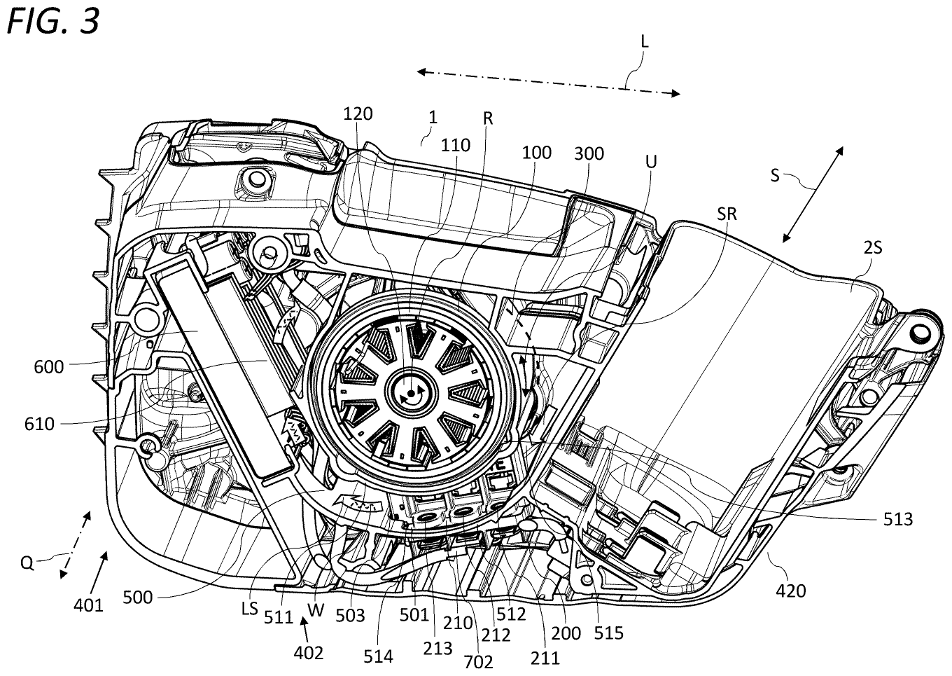

The housing parts 410 and 420 are essentially connected form-fit to the housing parts 430 and 440 and form a further partial section of the slot 2S, at the end of which respective slot contact elements for transmitting electrical energy and/or electrical signals are arranged inside the electric tool 1 (see also FIG. 3, for example). In an assembly state of the energy supply device 2, the slot contact elements make contact with complementary formed contact elements of the energy supply device 2 in order to transmit electrical energy in an operating state.

Two air passage openings 411 and 412 are formed on the housing 400, the respective location and outline of which are marked with dotted lines. In the present embodiment of the electric tool 1, the housing part 410 comprises the first air passage opening 411 and the second air passage opening 412. The first air passage opening 411 is formed on the housing part 410 at the front side 401, whereas the second air passage opening 412 is formed substantially on the bottom side 402 of the housing part 410.

In the area of the first air passage opening 411, ribs of the housing part 410 are formed, which are arranged at a distance from one another. For reasons of clarity, the ribs are not marked in more detail and serve primarily to prevent bodies and/or objects from penetrating into the interior of the housing 400. Analogous to the first air passage opening 411, ribs are also arranged in the area of the second air passage opening 412 in order to prevent bodies and/or objects from penetrating into the interior of the housing 400.

The first air passage opening 411 is, in particular, an air inlet opening 411. Air from an environment of the electric tool 1 can flow into the housing 400, that is, into the interior of the housing 400, via the air inlet opening 411. The second air passage opening 412 is in particular an air outlet opening 412. An air flow LS within the housing 400 can flow out of the housing 400 via the air outlet opening 412, in particular in order to substantially dissipate a heat W generated inside the housing 400 during an operating state from the housing 400 and thus to realize cooling of the electric tool 1. The air inlet opening 411 and the air outlet opening 412 are fluidically connected to one another inside the housing 400 via a duct 500. In the illustration in FIG. 1, a partial section or a duct segment of the duct 500 is visible behind the ribs of the air inlet opening 411 inside the housing 400.

The electric tool 1 comprises a drive unit 100 for generating a torque (see FIG. 3), which is represented in FIG. 1 by rotational axis R. Furthermore, the electric tool 1 is characterized and/or defined by a longitudinal direction L and by a transverse direction Q, wherein the transverse direction Q is perpendicular to the longitudinal direction L. The longitudinal direction L can be a direction in which the electric tool 1 extends at its longest and thus, in terms of its dimensions, at its maximum in one direction. The rotational axis R extends in particular in the transverse direction Q and/or is arranged parallel to the transverse direction Q.

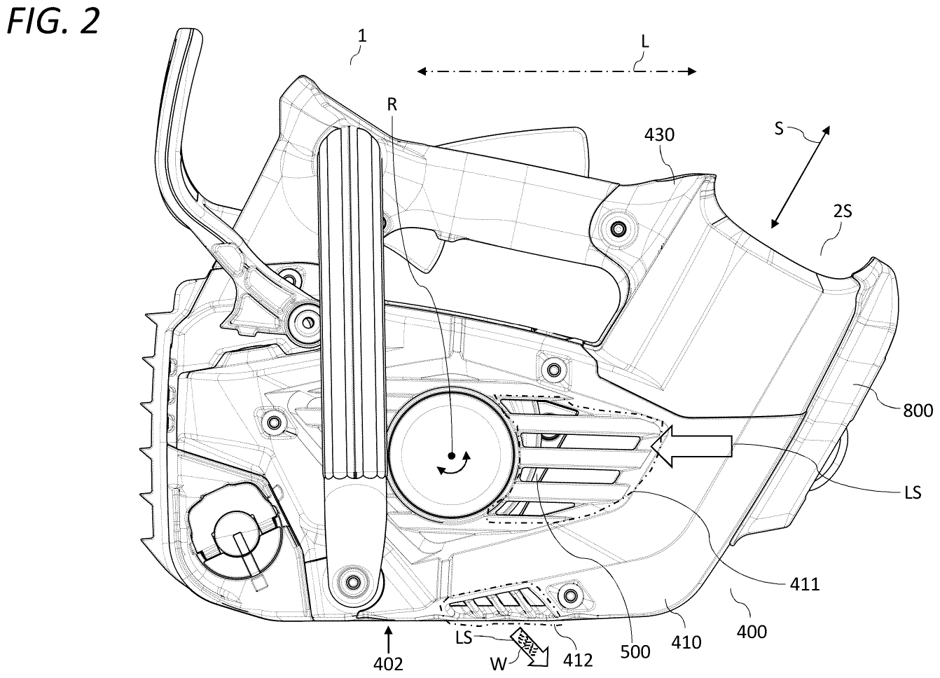

FIG. 2 shows the electric tool 1 from FIG. 1 in a front view (main view), wherein the energy supply device 2 is hidden. A separate protective element 800 is detachably mounted on the housing parts 430 and 440 as well as on the housing parts 410 and 420, which provides additional protection in the event of a collision of the electric tool 1.

The locations, i.e. the respective positions and orientations, as well as the outlines of the air inlet opening 411 and the air outlet opening 412 are clearly recognizable. The air inlet opening 411 and the air outlet opening 412 are formed on the differently oriented housing sides 401 and 402. This makes it possible, for example, to prevent heated air blown out via the air outlet opening 412 from being sucked in at the air inlet opening 411.

FIGS. 1 and 2 also show, for example, a lubricant tank for the saw chain, a hand guard, a handle tube and an actuating handle with actuating elements, although these are not marked for reasons of clarity. It is understood that the electric tool 1 comprises corresponding further units and/or elements to realize its intended function.

FIG. 3 shows a first section of the electric tool 1 from FIG. 1 in a perspective view, wherein the housing part 420 of the housing 400 is visible. In an assembly state of the energy supply device 2, the energy supply device 2 is accommodated within the slot 2S, wherein respective contact elements of the energy supply device 2 make electrical contact with correspondingly assigned slot contact elements of the slot 2S in order to be able to realize the transmission of electrical energy in the operating state of the electric tool 1.

Units and/or elements of the electric tool 1 are accommodated and/or arranged at least in sections in the housing part 420, which are described in more detail below.

As already indicated with reference to FIG. 1 with respect to the rotational axis R, the electric tool 1 comprises a drive unit 100 for driving the tool unit of the electric tool 1. In the embodiment shown, the drive unit 100 is formed as a rotary field machine in the form of a brushless three-phase motor 100 with a stator 110 as the stationary part and with a rotor 120 as the rotating part. The rotor 120 is formed to transmit a torque to the tool unit, i.e. to a tool element of the tool unit in the form of a drive sprocket for a saw chain. The drive sprocket can be immediately (directly) coupled to the rotor 120 outside the housing 400. In other words, the rotor 120 can represent a drive shaft of the drive unit 100. The drive unit 100 can be formed as an electric drive unit 100 known from the prior art.

Both the stator 110 and the rotor 120 each extend substantially in the transverse direction Q. With respect to its external dimensions, the drive unit 100 is characterized by an essentially cylindrical form. The drive unit 100 is encased at least in sections by corresponding walls and/or wall sections of the housing 400 and thus of the housing part 420, which will be described in more detail below in connection with the duct 500.

The electric tool 1 comprises a connection unit 200, which is immediately (directly) assigned to the drive unit 100 and/or is spatially immediately (directly) arranged on the drive unit 100, in particular on the stator 110. In particular, the connection unit 200 is mechanically coupled to the stator 110, for example by means of screw connections (see FIG. 4), and is used to transmit provided and converted electrical energy to the drive unit 100.

To convert the electrical energy provided by the energy supply device 2, the electric tool 1 comprises a power control unit 600, which is arranged in the housing 400. The power control unit 600 is configured to adjust the drive unit 100, in particular to regulate and/or control the electrical energy for the drive unit 100. In other words, the power control unit 600 can form the so-called power electronics of the electric tool 1 with switching elements, in particular semiconductor switching elements. The power control unit 600 can be configured as a power control unit 600 known from the prior art. The power control unit 600 is configured in particular for converting the electrical energy provided by the energy supply device 2 in a first form into electrical energy in a second form for supplying the drive unit 100. In particular, the power control unit 600 is used to convert a provided supply energy in the form of direct current into a drive energy in the form of alternating current. The drive unit 100 is in turn configured to convert the alternating current into mechanical energy in the form of kinetic energy.

The connection unit 200 is electrically connected between the drive unit 100 and the power control unit 600. In other words, the connection unit 200 establishes an electrical connection between the drive unit 100 and the power control unit 600.

The connection unit 200 comprises a connection block 210 for supporting connection contact elements 211, 212, 213. In other words, the connection block 210 represents a connection contact element holder for the connection contact elements 211, 212, 213 and thus forms a supporting structure of the connection unit 200. The connection contact elements 211, 212, 213 are configured for electrical connection and for mechanical connection with a respectively assigned electrical conductor, of which the electrical conductor 702 is marked in FIG. 3, which establishes an electrical connection between the power control unit 600 and the connection unit 200.

In an operating state of the electric tool 1, heat W is generated at the power control unit 600, at the drive unit 100 and also at the connection unit 200, in particular at the connection contact elements 211, 212, 213, due to the technology. The heat W generated must be dissipated from the housing 400 in order to ensure that the electric tool 1 functions as intended.

To dissipate the generated heat W, in particular at the connection unit 200, the air flow LS is used in conjunction with the duct 500 to guide the air flow LS along a flow direction SR. The air flow LS and the flow direction SR are shown in FIG. 3 and in further figures for closer illustration in each case with arrows with a closed line.

According to the disclosure, the duct 500 is defined in sections by the connection unit 200 for the drive unit 100 in order to substantially dissipate a heat W generated in the operating state at the connection unit 200 for the drive unit 100 from the housing 400 by means of the air flow LS. In other words, the connection unit 200 and here in particular the connection block 210 with the connection contact elements 211, 212, 213 forms itself and/or immediately (directly) a section of the duct 500 for guiding the air flow LS and thus for removing the generated heat W by means of the air flow LS. Convection takes place here, in particular defined convection in the form of forced convection. The dissipation of the heat W by means of the air flow LS in the duct 500 simultaneously ensures cooling of the connection block 200.

The duct 500 extends in sections in a circumferential direction U of the drive unit 100 between the drive unit 100 and the connection unit 200. As a result, heat W generated both at the drive unit 100 and, in particular, at the connection unit 200, i.e. heat W generated at the connection block 210, can essentially be dissipated by the air flow LS.

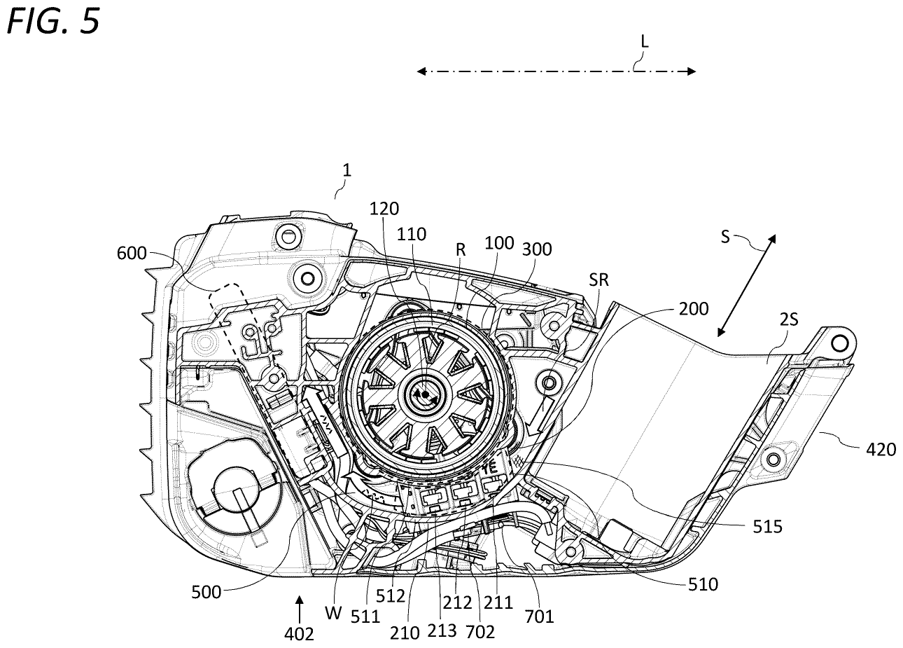

The duct 500 is formed, inter alia, by a first duct wall section 511 and by a second duct wall section 512, wherein the first duct wall section 511 encases the drive unit 100 in the circumferential direction U. The first duct wall section 511 and the second duct wall section 512 can be part of a duct segment 510 of the duct 500, the location of which is marked with a dashed line in FIG. 5. Both the first duct wall section 511 and the second duct wall section 512 are in particular each formed by a wall and/or by a wall section of the housing 400.

The connection block 210 can be formed plate-shaped and/or ribbed within the duct 500 and/or in the area of the definition of the duct 500. In other words, the connection block 210 can be formed substantially flat and comprise a plurality of ribs, which results in further improved cooling due to an increased surface as a convection surface.

In order to further optimize the dissipation of a heat W generated at the connection block 210 and in particular at the connection contact elements 211, 212, 213, the connection block 210 extends at least within the duct 500 substantially along the flow direction SR and/or substantially parallel to duct wall sections, which are arranged as side wall sections substantially perpendicular to the transverse direction Q and delimit the duct 500 in the transverse direction Q. In FIG. 3, the duct wall section 515 is characterized as a side wall section of the duct 500, which is formed by the housing 400.

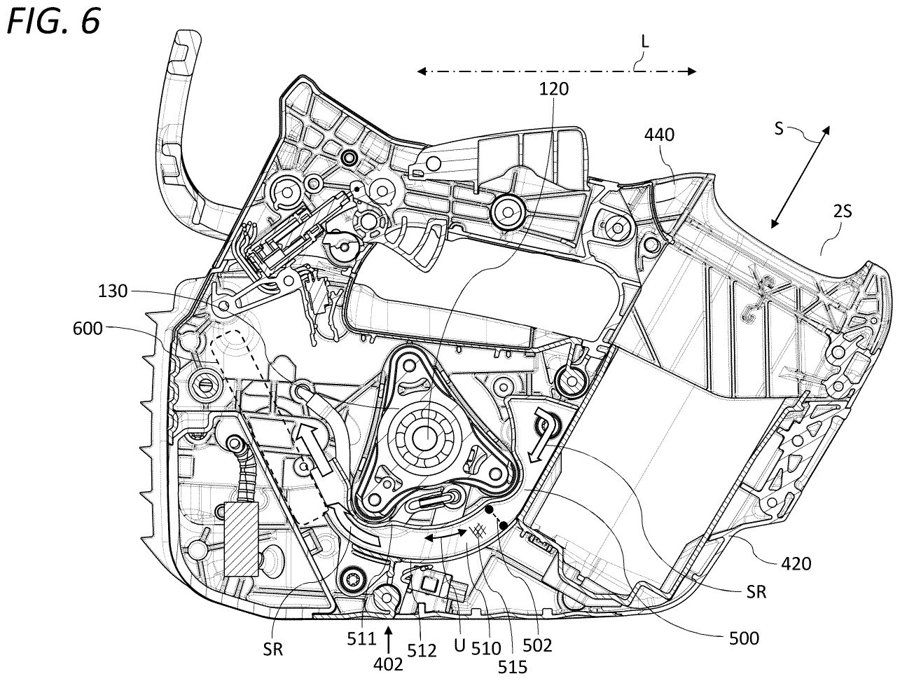

In the illustrated embodiment, the three connection contact elements 211, 212 and 213 are arranged one behind the other along the flow direction SR. Within the duct 500, the connection block 210 divides a duct cross-section 502 of the duct 500 (see FIG. 6) in sections along the flow direction SR and forms at least one duct wall section 501 of the duct 500.

A recess 513 is formed in the first duct wall section 511 and a recess 514 is formed in the second duct wall section 512. Both the recess 513 and the recess 514 each extend in sections substantially along the flow direction SR and are each formed complementary to the connection block 210, so that the connection block 210 protrudes through the recess 513 and through the recess 514.

A gap is formed between the connection block 210 and the recesses 513 and 514 in each case substantially along the flow direction SR and substantially transverse to the flow direction SR, of which the gap 503 is visible and marked in FIG. 3. The respective gap 503 can comprise a width in a range from approximately 0.5 mm to approximately 3.0 mm. The respective gap 503 can also comprise a width in a range from more than 0.0 mm to at least approximately 5.0 mm. In particular, the respective gap 503 can comprise a width in a range from about 0.5 mm to about 2.0 mm. Although the respective gap 503 does not significantly influence the air flow LS in the duct 500 with respect to the dissipation of generated heat W, air can be sucked into the duct 500 via the respective gap 503 by a negative pressure generated by the air flow LS, which in turn at least partially realizes a dissipation of generated heat at further points, units and/or elements.

In order to further improve the cooling of the electric tool 1, the duct 500 is immediately (directly) defined in sections by the power control unit 600 in the flow direction SR downstream of the connection unit 200 in order to essentially dissipate a heat W generated in the operating state at the power control unit 600 by means of the air flow LS. For this purpose, the power control unit 600 can comprise a plurality of cooling elements 610 in the form of ribs or fins, which extend in sections substantially along the flow direction SR and/or into the duct cross-section 502 of the duct 500 (see FIG. 6).

To generate an air flow LS between the air inlet opening 411 and the air outlet opening 412 within the duct 500, the electric tool 1 comprises a fan unit 300, which is not visible in FIG. 3, but is indicated by a dashed, curved line.

The fan unit 300 can be formed as an impeller with at least one blade, in particular with a plurality of blades, and thus as a paddle wheel in order to set the air present in the duct 500 in motion in an operating state of the electric tool 1. As a result, an air flow LS is formed between the air inlet opening 411 and the air outlet opening 412, which is accompanied at the air inlet opening 411 by suction of air from an environment of the electric tool 1, and which is accompanied at the air outlet opening 412 by a blowing out of sucked-in, heated air in the form of the air flow LS.

In contrast to a compressor, the fan unit 300 can be configured to convey the air flow LS by means of a comparatively low pressure increase. The fan unit 300, in particular the impeller, can be immediately (directly) coupled to the rotor 120 of the drive unit 100 and can be driven by the rotor 120. The fan unit 300 can be arranged inside the housing 400 on a side of the housing 400 which is arranged opposite to the housing side 401 of the air inlet opening 411 in the transverse direction Q. In other words, the fan unit 300 can be mounted on the motor shaft 120 and, in particular, can be arranged on the side of the motor shaft 120 facing away from the air inlet.

FIG. 4 shows the second section of the electric tool 1 from FIG. 1 in a perspective view, wherein the housing part 410 is now visible.

In this view, the recesses 513 and 514 in the duct wall sections 511 and 512 with respective gaps 503 can be seen, through each of which the terminal block 210 of the connection unit 200 protrudes. Furthermore, windings (coils) and other elements of the drive unit 100 in the form of the electric motor are clearly visible.

The air flow LS is guided as cooling air immediately (directly) onto the connection block 210 and further along the flow direction SR downstream immediately (directly) onto the power control unit 600, which ensures a more effective removal of generated heat W as a result of forced convection as a heat transport mechanism.

The connection block 210 comprises a mounting section for immediate (direct) mounting to the stator 110 of the drive unit 100. The mounting section is formed fork-shaped, with two spaced-apart and/or oppositely arranged arms being attached to the stator 110, for example by means of screw connections. The connection block 210 extends with the fork-shaped mounting section essentially perpendicular to the direction of the rotational axis R.

FIG. 5 shows the electric tool 1 from FIG. 1 in a first sectional view (front view), wherein units and elements of the electric tool 1 are hidden, so that the housing part 440, among other things, is visible. The fan unit 300 is shown schematically by means of a dotted line.

Furthermore, in the illustration in FIG. 5, the additional electrical conductor 701 is visible and marked, which makes mechanical and electrical contact with the connection contact element 211 in order to electrically connect the power control unit 600 to the connection unit 200. The connection can comprise a form-fit and/or a force-fit connection, for example a screw-clamp connection.

In addition, FIG. 5 graphically illustrates the penetration of the connection block 210 through the first duct wall section 511 and through the second duct wall section 512.

FIG. 6 shows the electric tool 1 of FIG. 1 in a second sectional view (front view), wherein the housing parts 420 and 440 are visible.

The rotor 120 is supported via the mounting flange 130 of the drive unit 100 in the housing 400 on corresponding walls and/or wall sections of the housing part 420, for example vibration-damped and/or by means of a roller bearing element.

The change in the duct cross-section 502 as the resulting flow cross-section of the air flow LS along the flow direction SR is clearly recognizable. The duct cross-section 502 can be tapered in sections along the flow direction SR and/or enlarged in sections in order to influence the air flow LS in a defined manner.

In this view, the duct 500 in the area of the connection block 210 is characterized by an arcuate segmental course, so that an average or resulting flow velocity of the air flow LS at the connection block 210 is increased, which in turn leads to a more effective cooling of the connection block 210.

The present disclosure can be used to provide an electric tool 1 and a corresponding method for operating an electric tool 1, which is characterized by an improved cooling concept.

The present disclosure is not limited to the embodiments described above. Rather, a large number of variants and modifications are possible, which also make use of the inventive concept and therefore fall within the scope of protection. In particular, the present disclosure also claims protection for the subject matter and the features of the subclaims independently of the claims referred to.

### LIST OF REFERENCE SIGNS

1 electric tool
2 power supply device
2S slot
100 drive unit
110 stator
120 rotor
130 mounting flange
200 connection unit
210 connection block
211 connection contact element
212 connection contact element
213 connection contact element
300 fan unit
400 housing
401 housing side
402 housing side
403 housing side
410 housing part
411 air passage opening, air inlet opening
412 air passage opening, air outlet opening
420 housing part
430 housing part
440 housing part
500 duct
501 duct wall section
502 duct cross-section
503 gap
510 duct segment
511 duct wall section
512 duct wall section
513 recess
514 recess
515 duct wall section
600 power control unit
610 cooling element
701 conductor
702 conductor
800 protective element
L longitudinal direction
LS air flow
Q transverse direction
R rotational axis
SR clow direction
U circumferential direction
W heat

What is claimed is:

1. An electric tool, comprising:
a drive unit for driving a tool unit of the electric tool during operation;
a connection unit that has at least one connection contact element for transmitting electrical energy from an energy supply device of the electric tool to the drive unit;
a fan unit for generating an airflow;
a housing that accommodates the drive unit, the connection unit for the drive unit, and the fan unit,
wherein the housing has a first air passage opening and a second air passage opening; and
a duct for guiding the airflow from the fan unit along a flow direction;
wherein the first air passage opening and the second air passage opening are connected to one another via the duct, and
wherein the duct is defined in sections by the connection unit and can dissipate heat generated at the connection unit from the housing by guiding the airflow during operation.

2. The electric tool according to claim 1,
wherein the duct extends at least in sections in a circumferential direction of the drive unit between the drive unit and the connection unit in order to dissipate heat generated at the drive unit by guiding the airflow during operation.

3. The electric tool according to claim 1,
wherein the connection unit comprises a connection block for supporting the at least one connection contact element, and
wherein the connection block forms a duct wall section of the duct for guiding the airflow or divides a duct cross-section of the duct in sections along the flow direction.

4. The electric tool according to claim 1,
wherein the connection unit is plate-shaped and/or ribbed at least within the duct.

5. The electric tool according to claim 1,
wherein the connection unit extends at least within the duct along the flow direction or parallel to at least one duct wall section of the duct.

6. The electric tool according to claim 1,
wherein the connection unit comprises at least three connection contact elements that are arranged within the duct in a longitudinal direction transverse to the flow direction or are arranged one behind the other along the flow direction.

7. The electric tool according to claim 1,
wherein the duct is defined by a first duct wall section and a second duct wall section,
wherein the first duct wall section encases the drive unit in sections in a circumferential direction, and the second duct wall section is spaced from the first duct wall section, and
wherein the first duct wall section and the second duct wall section each have a recess that extends in sections along the flow direction, through which the connection unit protrudes to electrically or mechanically connect the connection unit to the drive unit.

8. The electric tool according to claim 7, further comprising:
at least one gap formed between the connection unit and the recess of the first duct wall section or between the connection unit and the recess of the second duct wall section,
wherein the at least one gap extends along the flow direction or transverse to the flow direction, and
wherein the at least one gap has a width in a range from 0.5 mm to 5.0 mm.

9. The electric tool according to claim 1, further comprising:
a power control unit adapted to adjust the drive unit or the fan unit,
wherein the power control unit is accommodated in the housing, and
wherein the duct is defined in sections by the power control unit and can dissipate heat generated at the power control unit from the housing by guiding the airflow during operation.

10. The electric tool according to claim 9,
wherein the power control unit is arranged downstream of the connection unit in the flow direction.

11. The electric tool according to claim 9,
wherein the power control unit comprises at least one cooling element for transferring the generated heat, and
wherein the at least one cooling element extends in sections along the flow direction.

12. The electric tool according to claim 1,
wherein the duct within the housing extends in a transverse direction perpendicular to a circumferential direction of the drive unit and extends in sections in a spiral shape.

13. The electric tool according to claim 1,
wherein the duct within the housing extends in a transverse direction perpendicular to a circumferential direction of the drive unit and extends in sections in a straight line.

14. The electric tool according to claim 1,
wherein the first air passage opening can introduce airflow into the housing and is arranged as an air inlet opening on a first housing side,
wherein the second air passage opening for discharging the airflow from the housing is arranged as an air outlet opening on a second housing side, and
wherein the first housing side and the second housing side are aligned differently with respect to one another to prevent reintroducing of discharged airflow into the first air passage opening.

15. A method of operating an electric tool comprising a housing that accommodates a drive unit to drive a tool unit during operation, a connection unit having at least one connection contact element for transmitting electrical energy from an energy supply device to the drive unit, a fan unit for generating an airflow, a first air passage opening, a second air passage opening, and a duct connecting the first air passage opening and second air passage opening and for guiding the airflow along a flow direction, the duct being defined in sections by the connection unit, the method comprising:
operating the fan unit to generate the airflow in the duct; and
dissipating heat generated at the connection unit from the housing by guiding the airflow through the duct during operation.

16. The method according to claim 15, further comprising:
guiding the airflow along at least a portion of a circumferential direction of the drive unit within the housing.

17. The method according to claim 15, further comprising:
guiding the airflow through the duct along a flow path that is at least partially spiral-shaped or straight.

18. The method according to claim 15, further comprising:
introducing the airflow into the housing through the first air passage opening and discharging the airflow through the second air passage opening,
wherein the first air passage opening and second air passage opening are arranged to prevent discharged airflow from re-entering the first air passage opening.

19. The method according to claim 15, further comprising:
further comprising transferring heat from a power control unit to the airflow via a cooling element extending along at least a portion of the flow direction.

20. The method according to claim 15, further comprising:
adjusting the drive unit or the fan unit with a power control unit.
